(19) United States
(12) Patent Application Publication
(10) Pub. No.: US 2004/0115106 A1
(43) Pub. Date: Jun. 17, 2004

(54) High temperature fixed bed reactor

(76) Inventors: Tommy Hansen, Tikob (DK); Martin Ostberg, Roskilde (DK)

Correspondence Address: DICKSTEIN SHAPIRO MORIN & OSHINSKY LLP, 2101 L STREET NW, WASHINGTON, DC, 20037-1526, US

(21) Appl. No.: 10/700,522

(22) Filed: Nov. 5, 2003

(30) Foreign Application Priority Data
Nov. 15, 2002 (DK) PA 2002 01759

(51) Int. Cl. B01J 8/02

(52) U.S. Cl. 422/211; 422/218

(57) ABSTRACT

A reactor for processes involving reactions of gasses at high temperatures comprising a gas impermeable basket suitable for operation at elevated temperatures surrounded by a layer of insulation material, the insulation material being surrounded by a reactor shell suitable for operation at elevated pressures. The basket comprises an inlet channel and a wall surrounding a fixed catalyst bed, and the inlet channel is connected to the reactor shell forming a gas leak tight transfer for a feed gas. An electric heater can be installed on the outer surface of the wall around the inlet layer of the catalyst bed and the installed catalyst is in form of particles or a monolith. The reactor is particularly useful in catalytic partial oxidation of hydrocarbons.

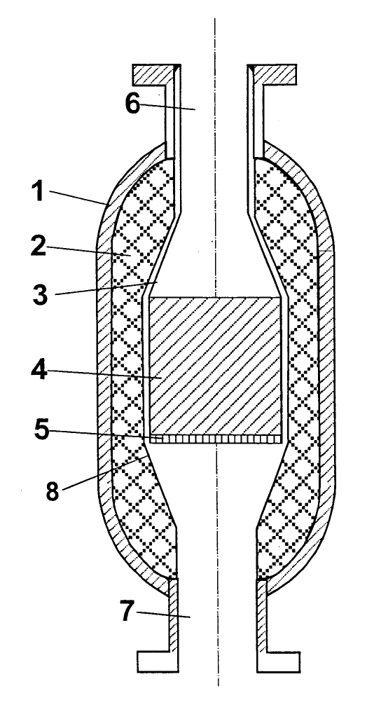

### BACKGROUND OF THE INVENTION

1. Field of the Invention

This invention relates to a fixed bed reactor for high-temperature reactions, where the reactor is insulated on the inside of a pressure shell to keep a lower temperature of the shell material.

The invention is specifically directed to a reactor designed to avoid unintended chemical reactions at high gas temperatures.

2. Description of Related Art

Chemical reactions releasing heat often take place at elevated temperatures and pressures in catalytic beds. The type of insulation used in corresponding reactors depends on the temperature inside the reactor and can be build either of fibre materials or of several layers of castable materials varying in insulation ability and temperature resistant. If castable materials are used, the outer layer will typically have very good properties for insulation, but on the expense of the temperature stability. Therefore, it is necessary to have inner layers with better temperature stability, but lower insulation abilities. Often the last inner layer consists of ceramic bricks with very high temperature stability. These can be made of alumina, zirconia or a mixture of these materials. If fibre materials are used there will typically only be one type, since these often posses good temperature stability and insulation properties at the same time.

The presence of a refractory lining or fibre insulation introduces reactor by-pass either because of the porosity of the refractory layers or because of imperfect construction having small gaps in the layer. These by-pass flows will be dependent on the pressure drop of the reactor, which in the case of a fixed bed of catalyst depends on flow through the reactor and the void of the catalyst. A by-pass may lead to undesired by-products formed in the reactor or even in the exit of the reactor.

### SUMMARY OF THE INVENTION

The invention is specifically directed to a reactor for processes involving reactions of gasses at high temperatures comprising a gas impermeable basket suitable for operation at elevated temperatures surrounded by a layer of insulation material, the insulation material being surrounded by a reactor shell suitable for operation at elevated pressures, wherein the basket comprises an inlet channel and a wall surrounding a fixed catalyst bed, and wherein the inlet channel is connected to the reactor shell forming a gas leak tight transfer for a feed gas.

This minimises or completely avoids the possibility of by-pass. Consequently, unintended reactions of feed gas by-passing the catalyst are avoided as well. An example is catalytic partial oxidation of a hydrocarbon feed, where bypass of the catalyst leads to thermal cracking instead of partial oxidation. The thermal cracking is furthermore exthermal.

Thereby, the invention makes it possible to use less expensive materials for the pressure shell and it decreases the necessary thickness of the shell meaning less material and cheaper reactor.

### BRIEF DESCRIPTION OF THE DRAWINGS

The sole FIGURE is a schematic drawing of a preferred embodiment of the invention.

### DETAILED DESCRIPTION OF THE INVENTION

The invention provides a reactor design, where the possibility of by-pass is prevented in a fibre insulated or refractory lined reactor. In the following, reference to the figure is made. The reactor is build having an outer metallic pressure shell 1. This could be made of stainless steel or other similar construction materials depending on the shell temperature and chemical composition of the process gas. The pressure shell is protected by an insulation layer 2. In the case of a refractory lined reactor, the inside of the pressure shell is lined with one or more refractory layers having materials with high insulation properties as outer layers and high-temperature resistant layers as inner layer/layers. While all outer layers typically are castable, the inner layer often consists of ceramic bricks having very good temperature stability.

Inside the reactor a metallic basket 3 is introduced containing a fixed bed of catalyst 4. This gas tight basket is fixed to the reactor shell at the inlet 6. The function of the metallic basket is to contain the fixed bed of catalyst and to prevent the feed gases to enter the insulation material. Thereby, by-pass of the fixed bed and unintended reactions outside the catalyst bed are prevented. The reacted gas leaves the fixed bed through a grid 5. There may be an additional flow channel connected with the metallic basket, but it is not required. After the gas leaves the gas tight basket, the reacted gas has access to penetrate into the insulation layers as the insulation inner surface 8 is porous. When the reactor is pressurised, this may happen and it is obtained that the portion of gas, which enters to the outside of the metallic basket, only consists of reacted gas. The gas leaves the reactor through the outlet 7.

The metallic basket is only dimensioned to withstand the weight of the fixed bed and the pressure difference created by having a flow through the fixed bed. Since the material of the metallic basket needs to be high-temperature resistance and inert towards undesired reactions, the material is often a much higher alloyed material than the material used for the above mentioned pressure shell, for example Inconell 600. Alternatively, the inner surface of the basket can be coated with a ceramic material such as alumina or zirconia. This means that to obtain the cheapest possible reactor only a minimum of this material should be used. Therefore it is desirable to minimise the necessary thickness of the basket by having it to withstand only the absolute necessary pressure difference, whereas the main pressure shell is designed for the full internal pressure, however, at a much lower temperature.

In another embodiment of the invention an electric heater can be installed on the outer surface of the wall around the inlet catalyst layer. This serves to heat-up the feed gas and the catalyst to reaction temperature when a cold reactor has to be brought into operation. Additionally, the heater may also be used for obtaining the optimal reaction gas temperature during operation. The inside of the basket material at the position of the heater may additionally be coated with active catalytic material like platinum, rhodium, ruthenium or nickel to promote the partial oxidation reaction. This is to ease the initiation of the catalytic reactions when a heater is used.

The reactor is loaded with catalyst in form of particles or a monolith. The reactor is especially useful for catalytic partial oxidation of hydrocarbons, where the temperature of the reacting gas is in the range of 500° to 1300° C. and most typically 900° to 1200° C.

1. A reactor for chemical processes involving catalytic reactions of gasses at high temperatures, comprising
a gas impermeable basket suitable for operation at elevated temperatures surrounded by a layer of insulation material, the insulation material being surrounded by a reactor shell suitable for operation at elevated pressures,
wherein the basket comprises an inlet channel and a wall surrounding a fixed catalyst bed, and
wherein the inlet channel is connected to the reactor shell forming a gas leak tight transfer for a feed gas.

2. Reactor according to claim 1, wherein inner surface of the basket is coated with a ceramic material such as alumina or zirconia.

3. Reactor according to claim 1, wherein an electric heater is installed on the outer surface of the wall around the inlet layer of the catalyst bed.

4. Reactor according to claim 3, wherein inner surface of the basket at position of the heater is coated with a catalytic material active in partial oxidation.

5. Reactor according to claim 4, wherein the catalytic material comprises platinum, rhodium, ruthenium or nickel.

6. Reactor according to claim 1, wherein catalyst in the catalyst bed comprises particles or a monolith.

7. A method of using a reactor according to claim 1 for catalytic partial oxidation of hydrocarbons.

8. A method of using a reactor according to claim 1, wherein the temperature of the reacting gasses is in the range of 500° C. to 1300° C.

9. A method of using a reactor as recited in claim 8, wherein the temperature of the reacting gasses is between 900° C. and 1200° C.
